(19) United States
(12) Patent Application Publication
(10) Pub. No.: US 2025/0206285 A1
(43) Pub. Date: Jun. 26, 2025

(54) ELECTRIC BRAKING SYSTEM

(71) Applicant: HALDEX AB, Landskrona (SE)

(72) Inventors: Pontus Fyhr, Lund (SE); Anders Nilsson, Landskrona (SE); Kristoffer Nilsson, Lund (SE); Anders Lindqvist, Landskrona (SE)

(21) Appl. No.: 18/845,685

(22) PCT Filed: Mar. 10, 2023
(86) PCT No.: PCT/EP2023/056101

§ 371 Date: Sep. 10, 2024

(30) Foreign Application Priority Data
Mar. 11, 2022 (DE) 20 2022 101 338.1

(51) Int. Cl. B60T 13/74

(52) U.S. Cl. CPC B60T 13/741; B60T 2270/413

(57) ABSTRACT

An electric brake system for a commercial vehicle includes a brake actuator including first coils configured such that the electrical impact of the first coils generate a first braking force, and second coils configured such that the electrical impact of the second coils generate a second braking force, wherein the electrical impacts of the first coils and the second coils are controllable via a first electronic control unit and a second electronic control unit.

### TECHNICAL FIELD OF THE INVENTION

The invention relates to an electric braking system for a vehicle, in particular a commercial vehicle.

### BACKGROUND

WO 2018/114275 A1 discloses an electric braking system with at least two electric power sources, wherein one electric power source is based on a capacitor, while the other power source is a rechargeable power source, in particular a chemical power source in the form of an accumulator. The two different electrical power sources have different dynamic characteristics, for example with regard to fast power requirements or charging characteristics. Furthermore, the different power sources ensure different possibilities for monitoring the charge state, and the different power sources lead to different costs and different levels of reliability. A control device can be used to selectively activate one of the two power sources as required. A monitoring device monitors the charge level of the capacitor-based power source, in particular the voltage at different plates of the capacitor. Furthermore, the monitoring device monitors the flow of electrical energy from the capacitor-based power source to the electrical braking device or monitors the flow of electrical energy from the rechargeable power source to the capacitor-based power source. According to the result of the monitoring, a warning signal can be given to the driver if the charging level falls below a threshold of the charging level. It is possible to control the flow of electrical energy between the power sources on the basis of the monitored charge levels. Electrical consumers that are not safety-relevant and are not used for braking can be deactivated if a low charge level has been determined. Furthermore, the operation of the electric braking device can be adjusted if the charge level is low or the charge level is below a threshold. It is also possible that an emergency braking action is triggered in this case in order to brake the vehicle to a standstill. It is also proposed that the monitoring device detects a fault or failure of the capacitor-based power source and that the power supply to the electric braking device switches to the supply from the rechargeable power source when such a fault or failure is detected. In this case, the fault or failure of the capacitor-based power source can be detected on the basis of a rapid drop in the charge level, high currents between the capacitor plates or on the basis of improper charging behavior of the capacitor-based power source. In one embodiment the electric braking system can be operated in two different operating states: In a high-energy operating state, the actuation of the electric brake actuator according to a predetermined characteristic depends on the electrical impact of the electric actuator, whereby a stronger brake actuation requires a stronger electrical impact of the brake actuator. A high constant electrical impact on the brake actuator is also required to generate a high constant braking force. The publication proposes the use of an additional low-energy operating state in which the brake actuator is not electrically impacted proportionally or according to the specified characteristic in order to maintain a constant braking force. Instead, a holding device, locking device, fixing device or braking device is actuated for a braking force to be kept constant, which uses a low energy level to keep the previously induced brake actuation at a constant level. In the event that a change in the extent of the brake actuation is required, the low-energy operating state or holding state, fixing state, locking state or braking state is removed and the control logic causes a switchover to the high-energy operating state of the electric brake actuator, in which the braking force then again depends on the extent of the electrical impact. The publication also proposes a recovery operating state of the brake system. In the recovery operating state, energy stored in the braking device or the brake actuator can be recovered by releasing the electric brake actuator and used to recharge the capacitor-based power source. For one embodiment example, two capacitor-based power sources are assigned to the electric brake actuators on different sides of an assigned vehicle axle. In a normal operating state, the two capacitor-based power sources are separated from each other, whereby these can then each be responsible for supplying power to an associated wheel-side wheel brake unit. On the other hand, in a fault operating state, one of the two capacitor-based power sources is connected to the electric brake actuators of both wheel brake units. It is possible that in the electric brake system, the electric brake actuator generates an actuating force that is transmitted directly or indirectly to the brake element (in particular the brake lining), so that the braking force on the brake element corresponds to the actuating force of the brake actuator, is proportional to it or depends according to another predetermined dependency. A gearbox or a brake lever can be arranged between the electric brake actuator and the brake element, in particular the brake lining. However, it has been shown that for some embodiments it may be advantageous to use a mechanical self-reinforcing mechanism in the electric braking device. In this regard, reference is made to the publications EP 1 977 134 B1 or US 2013/0008749 A1, which use a self-reinforcing mechanism with ramps, or reference is made to other self-reinforcing mechanisms known from the state of the art. These self-reinforcing mechanisms can be used to generate large braking forces with relatively small actuation forces and/or to generate a non-linear force transmission transmission characteristic between the actuation force and the braking force on the braking element. However, a “conventional” electric braking device can also be used, which has a plunger that is mechanically connected to a braking element such as a brake lining in order to impact the braking element. Any transmission units (with a rotatable brake lever, etc.) can be arranged between the electric brake actuator and the plunger. The publication also discloses the use of a brake actuator having first and second windings. The first windings may be supplied (in particular during a normal operating condition) with electrical power from the first power source based on a capacitor sator. If the power supply to the first windings from the first capacitor-based power source exhibits an abnormality, the second capacitor-based power source or the rechargeable power source can be activated. In this case, the second capacitor-based power source or the rechargeable power source supplies the second coils of the electric brake actuator with electrical power. In this case, the different coils can be dimensioned specifically for the different operating states, namely the first coils for the normal operating state and the second coils for the abnormal operating state (for example for emergency brake actuation, parking the vehicle and the like). Instead of such an embodiment in which the different coils are only used alternatively and not simultaneously in the same operating state, it is also possible that in a “boost operating state” the different coils of the electric brake actuator are electrically impacted simultaneously, so that the effects and the forces generated by the two coils add up. It is possible that the two coils are impacted by one and the same capacitor-based power source or that the two coils are impacted by different capacitor-based power sources.

### Problem of the Invention

The invention is based on the problem of proposing an electric braking system which is improved in particular with regard to reliability, monitoring and/or the possibilities for controlling or regulating the braking force.

### DESCRIPTION OF THE INVENTION

The invention relates to an electric braking system. In the electric braking system, (at least) one brake actuator is present, which has first and second coils. If the first coils are impacted electrically, a first braking force of the brake actuator can be generated. If second coils of the brake actuator are impacted, a second braking force of the brake actuator is generated. According to the invention, it is proposed that the electrical impact of the first coils and the second coils of the brake actuator can be controlled via a first electronic control unit and a second electronic control unit. In this case, the electrical impact of the first coils on the one hand and the second coils on the other hand can be carried out alternatively by the two electronic control units, so that only one of the coils is electrically impacted at any one time and this coil is then responsible for generating the entire braking force of the brake actuator. On the other hand, it is also possible to operate in boost mode (at least in partial operating ranges), in which the first and second coils are electrically impacted simultaneously, so that the braking force of the brake actuator results from the sum of the braking forces generated by the first coils and the second coils.

The use of the two electronic control units initially enables redundant control. On the other hand, it is possible for the electronic control units to monitor each other, which makes it possible to diagnose faults in the control units. If an error is detected by this monitoring, a switchover to an emergency operating mode can take place and the control by the electronic control unit with the detected error can be terminated, which means that control by the other electronic control unit can then take place.

For a particular proposal of the invention, the first control unit and the second control unit have different scopes of functions in a normal operating mode. For example, it is possible for the two control units to work together in the normal operating mode in the manner of master-slave control units, with the master control unit then having a greater range of functions than the slave control unit or taking over a partial range of the control functions of the slave control unit. In extreme cases, the first control unit can determine both the control signal for the electrical impact of the first coils and the control signal for the impact of the second coils. Such a control signal can then be “looped through” by the second control unit, for example.

It is also possible that the second control unit then only performs monitoring functions and represents a redundant control unit in the event of a detected fault and takes over control from the first control unit if a fault is detected, whereby the previous slave control unit can then become the master control unit.

Furthermore, it is possible that in a normal operating mode, each of the two control units is responsible for controlling the coils assigned to it. Only in the event of a fault can the non-faulty control unit also take over the control of the coils whose impacts were previously controlled by the faulty control unit in the manner of a master control unit, or take over at least part of them.

In principle, it is possible that only one control unit has a connection for a bus system and then a signal from the bus system is transmitted from the first control unit to the second control unit. For one proposal of the invention, the first control unit and the second control unit each have a connection for a bus system. In this case, the two connections of the control unit can be connected to the same bus system so that they receive the same bus data. However, it is also possible that the connections of the control units are connected to different bus systems so that they receive different bus data. The different bus data may contain comparable information or information of the same type. To give just one example, bus data from a brake pedal sensor of a first sensor type (for example an analog sensor with an analog brake signal) can be transmitted via the connection of the first control unit, while the bus data transmitted to the connection of the second control unit contains sensor data of a second sensor type (for example a brake signal in the form of a pulse-width modulated signal, a brake signal from a central vehicle control unit, a brake signal from an autonomous driving system, etc.).

For a particular embodiment of this solution concept, the first control unit and/or the second control unit are/is connected to a central control unit of the vehicle via a connection and a bus system connected to the connection. In addition, the first control unit and/or the second control unit are connected to a control unit of an axle control module via a connection and a bus system connected to the connection, whereby this can also be an axle control module of another axle. Finally, the first control unit and/or the second control unit can/can also be connected to a brake pedal sensor via at least one connection and a brake signal line connected to the connection. In this case, it is possible that data of different types, in particular brake signals generated and/or transmitted in different ways, are transmitted to the first control unit and/or the second control unit via the different connections and the bus systems and the brake line.

In the context of the invention, the first control unit and the second control unit may well be electrically separate from one another so that they operate independently. For one proposal of the invention, the first control unit and the second control unit are connected to each other via a connecting line. For example, data can be transmitted between the control units via this connecting line. It is also possible that the control units are coordinated by the first control unit and the second control unit via the connecting line. It is also possible that a control unit is monitored by the other control unit (and possibly vice versa) via the connection line. In the event that in normal operating mode, as explained above, one control unit serves as the master control unit while the other control unit serves as the slave control unit, control signals generated by the master control unit can be transmitted to the slave control unit via the connection line.

The connecting cable can be designed as an optical or galvanic connecting cable. Preferably, a system packet interface (SPI) or an isolator element is arranged in the connecting line, which enables the desired transmission of data, but avoids other transmissions that could lead to damage to a receiving control unit in the event of a fault in the transmitting control unit.

For an electric braking system according to the invention, the first control unit has control logic on the basis of which the second control unit is monitored. Alternatively or additionally, the second control unit can have corresponding control logic for monitoring the first control unit.

In the event that braking signals are supplied to the two control units within the scope of the invention, at least one control unit can have control logic which carries out a plausibility check of the braking signals supplied to the control units. If the brake signals originate from different sensors or control units or if the brake signals have been transmitted via different data lines, the control logic can detect if the received brake signals deviate from one another as a result of a sensor error or a transmission path. The plausibility check can be based on predetermined criteria (such as a deviation of the braking signals with regard to an amount by a maximum percentage, a deviation in the rates of change or temporal derivations of the braking signals, etc.). If the plausibility check leads to the result that the brake signals deviate from each other, a second step can optionally be carried out to determine which of the two different brake signals is more reliable. The control unit can then be transferred to the control unit to which the more reliable brake signal is transmitted.

It is possible that both a control signal sensor and a force sensor are present in a brake actuator. The control signal sensor detects, for example, an actuation distance of the brake actuator or a rotation angle of a drive shaft of the brake actuator. In contrast, the force sensor determines an actuation force of the brake actuator at any point between the brake actuator and the brake element, in particular the brake lining. Under certain circumstances, both the actuating signal from the actuating signal sensor and the force signal from the force sensor can be evaluated in one or both control units and used to control the electrical impact on the coils.

On the other hand, however, a predetermined linear or non-linear or any functional dependency may exist between the control signal of the control signal sensor and the force signal of a force sensor, so that control or regulation of the brake actuator by the control units is also possible (at least with reduced accuracy) solely on the basis of the control signal or solely on the basis of the force signal. For a proposal of the invention, it is therefore proposed that the first control unit is supplied with a measurement signal of an actuating signal of an actuating signal sensor of the brake actuator, while the second control unit is supplied with a measurement signal of a force signal of a force sensor of the brake actuator. The first control unit thus performs control or regulation on the basis of the control signal of the control signal sensor, while the second control unit ensures control or regulation on the basis of the force signal of the force sensor. This can either always be the case or only in the event of an error in one of the control units or an error in the generation or transmission of one of the aforementioned measurement signals.

In principle, it is possible that the electrical power supply for the electrical loading of the two coils comes from the same power source. It is at least temporary or always possible for the electrical power supply to the first coils and the second coils of the brake actuator to come from different power sources (in particular those based on a capacitor), thus ensuring a redundant power supply.

Within the scope of the invention, it is possible that the first control unit and the second control unit do not directly generate the electrical signal for impacting the coils, but merely generate a control or regulation signal containing less energy. For one proposal of the invention, this can then be used to control an associated amplification device, which generates an electrical impact signal for the associated coils of the brake actuator from the control signal of the control unit. In particular, this amplification device can be a transistor or “MOSFET” with an associated driver device. The amplification device can be integrated into the control unit, flange-mounted to it or otherwise connected to it, integrated into a common module with the control unit or arranged externally from a module with the control unit so that the control signal is transmitted from the control unit to the amplification device via an external line connection.

For one proposal of the invention, the electric braking system has an axle control module, which serves to control the brakes of the vehicle wheels on an axle of the commercial vehicle. In this case, the first control unit and the second control unit can be integrated into the axle control module.

In addition, the first and second amplification devices can also be integrated into the axle control module. In this case, the signal generated by the amplification device for impacting the coils is preferably transmitted to a wheel brake unit of the axle via an external line. However, it is also possible that an axle control module is integrated into a wheel brake unit, while the other wheel brake unit assigned to the axle is then connected to the axle control module via a line connection.

In the electric brake system according to the invention, for example, the axle control module can be connected to two wheel brake units of an axle. In this case, the first control unit has control logic for independently controlling the electrical impact of the first coils of the brake actuators of the two wheel brake units. It is possible that the control signal generated by the first control unit for a right-hand wheel brake unit differs from the control signal generated by the first control unit for the left-hand wheel brake unit of the same axle. The different control signals can then be amplified via separate amplification devices. The electrical impact signals from the amplification devices, which are then also different, can then be fed to the two associated wheel brake units, where they then act on the first coils. Accordingly, the second control unit can have control logic for independent control of the electrical impact of the second coils of the brake actuators of the two wheel brake units on the different sides of the axle.

In another variant of the invention, the first control unit and the second control unit are integrated into a wheel brake unit. Thus, the wheel brake units are designed as “intelligent” units in which the determination of the suitable electrical impact on the coils takes place. For this purpose, the wheel brake units can then have suitable connections and interfaces so that the required data, such as braking data in particular, can be made available to the control units.

It is possible that the first and second amplification devices are also integrated into the wheel brake unit. In this case, for example, the wheel brake unit can have an interface or a connection via which the wheel brake unit communicates with an axle control module or a central control unit, an autonomous driving system, a bus system or even a brake signal transmitter.

For another proposal, an axle control module is connected to two wheel brake units of an axle, in particular a right wheel brake unit and a left wheel brake unit. In this case, the axle control module can have two power sources (in particular power sources based on a capacitor). A first power source is then connected in each case to the first amplification devices of the two wheel brake units, while the second power source is connected in each case to the second amplification devices of the two wheel brake units.

In principle, the brake actuators can be of any design, so that the invention also includes brake actuators in which the braking force generated is dependent on the electrical impact in accordance with the pre given dependence. For a particular proposal of the invention, brake holding devices of the brake actuator are used as described at the beginning for the state of the art according to WO 2018/114275 A1 and which, in addition to a high-energy operating state or normal operating state, also have a low energy operating state. In the low-energy operating state, a braking force of the brake actuator is maintained by actuating the brake holding device (in particular a locking device, a fixing device, a holding device or a braking device), which can then at least reduce the electrical impact on the coils. For this embodiment, the invention proposes that the two control units are each connected to a brake holding device of the brake actuator.

Advantageous further embodiments of the invention are shown in the patent claims, the description and the drawings.

The advantages of features and of combinations of several features mentioned in the description are merely exemplary and can have an effect alternatively or cumulatively, without the advantages necessarily having to be achieved by embodiments according to the invention.

With regard to the disclosure content—not the scope of protection—of the original application dungs documents and the utility model, the following applies: Further features are to be taken from the drawings—in particular the geometries shown and the relative dimensions of several components to each other as well as their relative arrangement and operative connection. The combination of features of different embodiments of the invention or of features of different patent claims is also possible in deviation from the selected relationships of the patent claims and is hereby suggested. This also applies to those features which are shown in separate drawings or are mentioned in their description. These features can also be combined with features of different patent claims. Likewise, features listed in the patent claims may be omitted for further embodiments of the invention, but this does not apply to the independent patent claims of the registered utility model.

The features mentioned in the patent claims and the description are to be understood with regard to their number in such a way that exactly this number or a greater number than the number mentioned is present, without the explicit use of the adverb “at least” being necessary. If, for example, one element is mentioned, this is to be understood as meaning that exactly one element, two elements or more elements are present. These features can be supplemented by other features or be the only features that make up the respective product.

The reference signs contained in the patent claims do not constitute a limitation of the scope of the objects protected by the patent claims. They merely serve the purpose of making the patent claims easier to understand.

### BRIEF DESCRIPTION OF THE FIGURES

In the following, the invention is further explained and described with reference to preferred embodiments shown in the figures.

FIG. 1 schematically shows an electric brake system with several axles, each of which has an axle control module and wheel brake units.

FIG. 2 schematically shows an electric brake system with an axle control module and two associated wheel brake units, whereby the wheel brake units each have two control units that control the impact of the coils of the brake actuators.

FIG. 3 schematically shows an electric brake system with an axle control module and two associated wheel brake units, whereby the axle control module has two control units which control the impact of the coils of the brake actuators.

FIG. 4 schematically shows an electric brake system in the area of an axle with wheel brake units, each of which is assigned an axle control module, whereby the axle control modules each have two control units that control the activation of the coils of an assigned brake actuator.

### DETAILED DESCRIPTION

In the figures, the same reference numbers are sometimes used for parts and components that correspond or resemble each other in terms of design and/or function, whereby these can then be distinguished from each other by the letters “a”, “b”, . . . and/or the suffix “−1” or “−2”. Here, the addition “a” or “b” can characterize the assignment of the part or component to the first coils or the second coils, while the addition “−1” or “−2” can characterize the assignment to a left or right wheel brake unit. In the present application text and in the patent claims, reference can then be made to the parts and components with or without the respective addition, which can then mean one such part or component, several such parts or components or all parts or components.

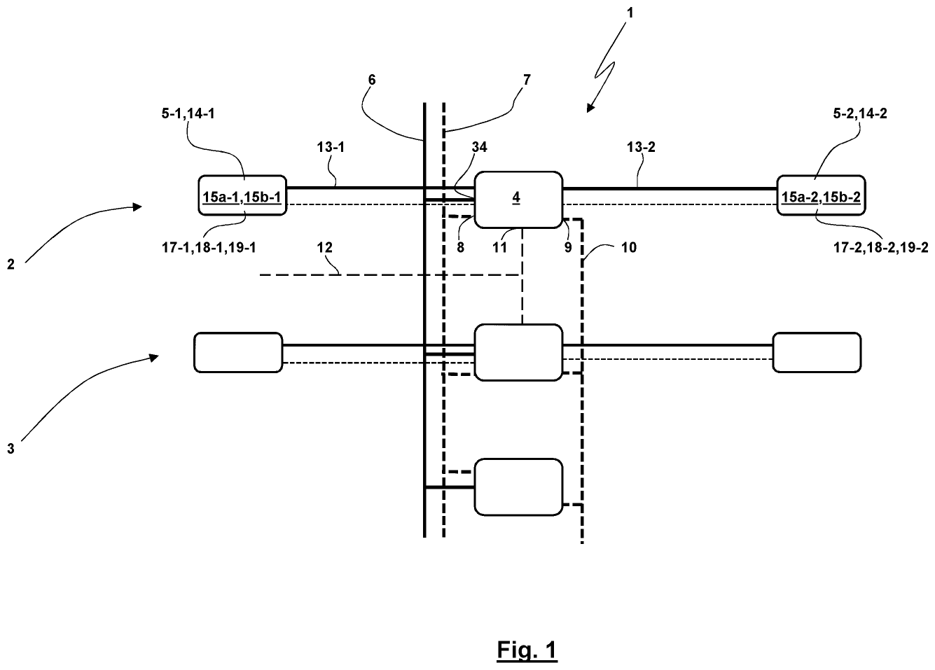

FIG. 1 shows a highly schematized electrical brake system 1 in the area of two axles 2, 3. The structure of the electrical brake system 1 in the area of the axles 2, 3 is the same in each case, whereby the structure is explained as an example for axle 2:

In the area of the axle 2, the electric brake system 1 has an axle control module 4 and wheel brake units 5-1 and 5-2, whereby the wheel brake unit 5-1 is assigned to the left-hand side of the vehicle of the axle 2 and the wheel brake unit 5-2 is assigned to the right-hand side of the axle 2. The axle control module 4 is connected to an electrical power supply 6, which may be the on-board power supply, preferably a 12 V or 24 V supply.

Furthermore, a connection 8 of the axle control module 4 is connected to a vehicle bus system 7. In addition, the axle control module 4 is connected to a further bus system 10 via a connection 9. The bus system 10 is preferably designed independently of the vehicle bus system 7, whereby the bus system 10 and the vehicle bus system 7 can transmit correlating signals such as brake signals, whereby the transmitted brake signal of the vehicle bus system 7 and the bus system 10 can differ due to the sensor that generates the brake signal, the transmission path, the transmission format and the like. It is also possible that a brake signal from an autonomous driving system is transmitted via one of the bus systems 7, 10, while a brake signal specified by the user at a brake pedal is transmitted via the other bus system 10, 7. Alternatively or cumulatively, it is possible that the bus system 10 serves to couple and coordinate the axle control modules 4 of the different axles 2, 3, so that the operation of an axle control module 4 of one axle 2 can also be influenced or monitored by the operation of the axle control module 4 of the other axle 3 (possibly and vice versa).

In addition, the axle control modules 4 have a connection 11 that is connected to a brake signal line 12. The brake signal line 12 can, for example, be connected directly to a brake pedal signal transmitter. It is also possible that two such connections 11 are provided, which are then connected redundantly via parallel brake signal lines 12 to redundant brake signal transmitters of the brake pedal.

The electrical power supply 6 is provided via a connection 34 of the axle control module 4.

The axle control modules are connected to the wheel brake units 5-1 and 5-2 via impact lines 13-1, 13-2. The impact lines 13 carry the currents and voltages via which are applied to coils 15a, 15b of the brake actuators 14-1, 14-2 of the wheel brake units 5-1, 5-2.

The brake actuators 14 each have first coils 15a and second coils 15b. The first coils 15a and the second coils 15, 16 each consist of a set of three coils for the three different phases for the electrical impact. Furthermore, the brake actuators 14 can each have a force sensor 17, a travel sensor 18 and/or a brake holding device 19.

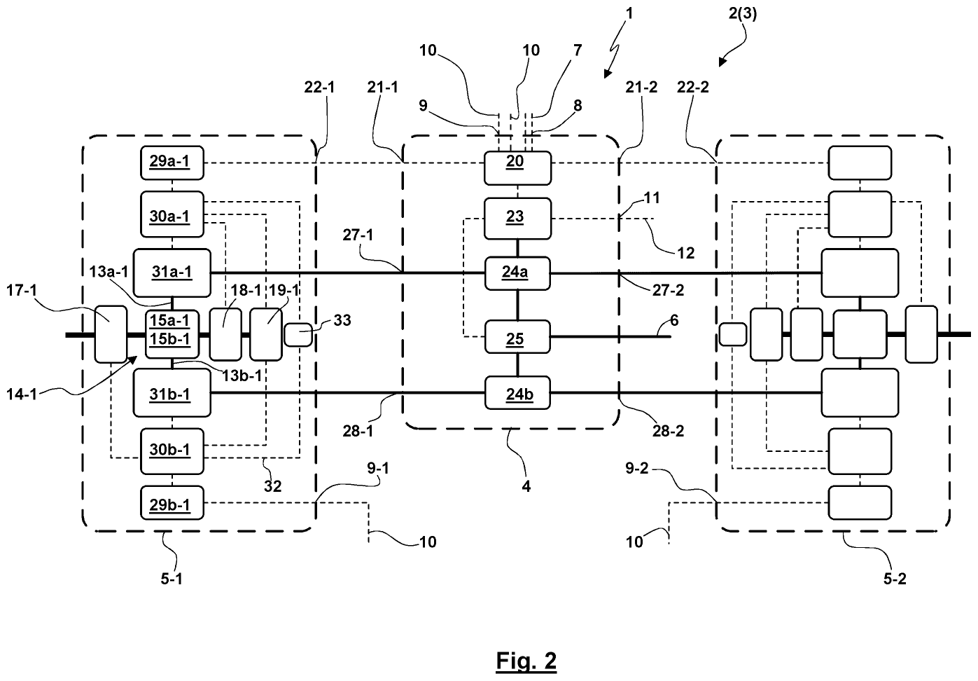

FIG. 2 shows the brake system 1 in the area of an axle 2 or 3.

For the embodiment example shown in FIG. 2, the axle control module 4 has two redundant connections 8, which are connected to redundant lines of the vehicle bus system 7, as well as a connection 9 for connecting the bus system 10, in this case for a connection with an axle control module 4 of another axle. The signals from the vehicle bus system 7 and the bus system 10 are received and processed by a CAN transceiver 20 by extracting the required data from the bus signals. The axle control module 4 has connections 21 via which CAN data can be transmitted from the CAN transceiver 20 to the corresponding connections 22 of the wheel brake units 5. Furthermore, the CAN data of the CAN transceiver 20 is transmitted to an electronic control unit 23 of the axle control module 4. The electronic control unit 23 is connected to a power source 24a, which is preferably based on a capacitor, and a voltage converter 25, this connection being used to control the power source 24a and/or the voltage converter 25 and/or to transmit operating data from the power source 24a or the voltage converter 25 to the control unit 23. The voltage converter 25 supplies both the power source 24a and a second power source 24b, which is preferably also based on a capacitor, with electrical power from the electrical power supply 6. In doing so, the voltage converter 25 converts the voltage of the power supply 6 to the voltage level required for the power sources 24a, 24b. If the electrical power supply 6 is an on-board power supply with 12 V or 24 V, the voltage can be converted to a voltage level of 48 V for the power sources 24a, 24b by means of the voltage converter 25. The power source 24a provides the required electrical power for the first coils 15a of the wheel brake units 5-1 via a connection 27. On the other hand, connections 28 of the axle control module 4 provide electrical power from the power source 24n for the second coils 15b of the wheel brake units 5.

In the example shown, the CAN transceiver 20 communicates with two other axle control modules 4 of two other axles via two separate bus lines 10.

The wheel brake units 5-1, 5-2 have the same design and are connected to the axle control module 4 in a corresponding manner, so that the structure and connection are explained below using the left-hand wheel brake unit 5-1 as an example:

The connection 22-1 of the wheel brake unit 5-1 is connected to a CAN transceiver 29a-1, so that the data from the CAN transceiver 20 of the axle control module 4 is transmitted to it. The data from the CAN transceiver 29a-1 is fed to a first control unit 30a-1 of the wheel brake unit 5-1, which controls the first coils 15a-1 on the basis of this data. For this purpose, the control unit 30a-1 controls an amplification device 31a-1, which is preferably a transistor. Based on this control, the amplification device 31a-1 generates the electrical impact signal in the impact line 13a-1 for the impact of the first coils 15a-1. A corresponding CAN transceiver 29b-1, a control unit 30b-1 and an amplification device 31b-1 are also provided for the control of the second coils 15b-1.

The brake actuator 14 of the wheel brake unit 5 also has an integrated force sensor 17. The force sensor 17 measures a force (which also includes a torque) in the force flow within the brake actuator 14 or on the path from the brake actuator 14 to a brake element such as a brake disc. The braking force can be determined from the force signal of the force sensor 17 using a predefined dependency. The force signal from the force sensor 17 is fed to the second control unit 30b.

In addition, the brake actuator 14 has an actuating signal sensor 18. The actuating signal measured by the actuating signal sensor 18 is fed to the first control unit 30a.

Finally, the brake actuator 14 has a brake holding device 19. The brake holding device 19 is controlled redundantly by the two control units 30a, 30b.

The control units 30a, 30b are connected to one another via a connecting line 32, with an insulator element 33, in particular in the form of an SPI, preferably being arranged in the connecting line 32.

For the embodiment example shown in FIG. 2, the wheel brake units 5-1 and 5-2 each contain the CAN transceivers 29a, 29b, the control units 30a, 30b and the amplification units 31a, 31b.

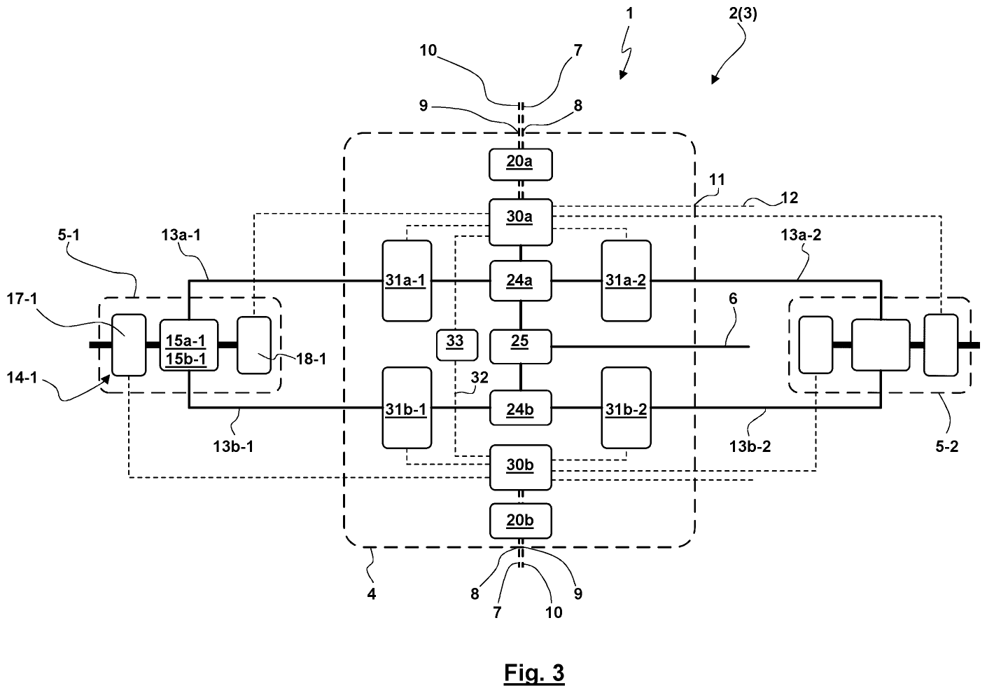

In the embodiment shown in FIG. 3, these components are integrated into the axle control module 4: In this case, the wheel brake units 5 only have the brake actuator 14 with the coils 15, 16, the force sensor 17 and the travel sensor 18.

Bus data from the bus system 10 and the vehicle bus system 7 are fed into the control unit 30a, 30b integrated in the axle control module 4 via connections 8, 9 via a CAN transceiver 20a, 20b arranged upstream. The control units 30a, 30b each control a pair of associated amplification devices 31a-1, 31a-2 for the first coils 15a-1, 15a-2 of the wheel brake units 5-1, 5-2, while the control unit 30b correspondingly controls a pair of amplification devices 31b-1, 31b-2 for the second coils 15b-1 and 15b-2 of the wheel brake units 5-1, 5-2. In this case, the booster devices 31 provide the electrical power for the wheel brake units 5 via external power lines 13 running between the axle control module 4 and the wheel brake units 5. The power supply of the booster devices 31a-1, 31a-2 by the power source 24a and the power supply of the booster devices 31b-1, 31b-2 by the power source 24b also takes place within the axle control module 4.

For the design example according to FIG. 3, complete redundancy is guaranteed in the event of a fault if a transmission of a brake signal via one of the alternative paths 7, 10, 12 has an error,
a control unit 30a, 30ba has a fault,
a CAN transceiver 20a, 20b has an error,
an electrical power supply 24a, 24b is impaired,
one amplification device or a pair of the amplification devices 31a-1, 31a-2 or 31b-1, 31b-2 fails or
one of the coils 15a, 15b fails.

Compared to the example shown in FIG. 2, it may be possible to save two control units

FIG. 3 shows that the brake system 1 can optionally be designed without brake holding devices 19, at least on some of the axles.

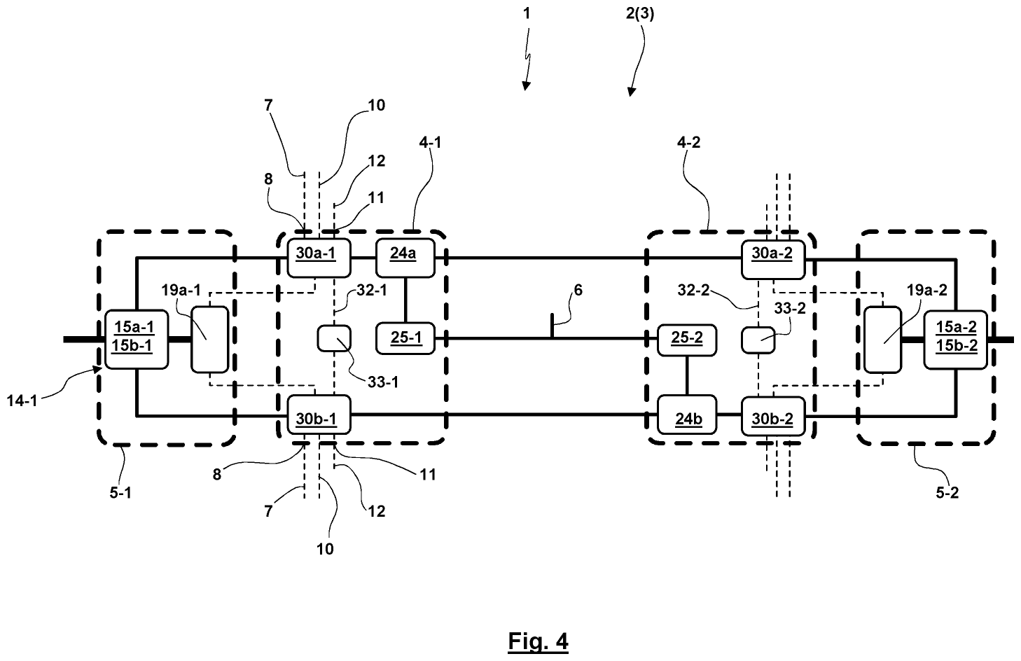

For the embodiment example of the electric brake system 1 according to FIG. 4, the axle control module 4 is divided into two axle control modules 4-1, 4-2, which are arranged at a distance from each other. According to FIG. 4, the axle control modules 4-1, 4-2 can also be arranged at a distance from the wheel brake units 5-1, 5-2 or these are flange-mounted to one another or even integrated into a single unit.

In this case, the axle control modules 4 have the control units 30a, 30b. These can control and impact the coils 15a, 15b directly or by interposing amplification devices 31a, 31b not shown here. The control units 30a, 30b also control the brake holding device 19 of the wheel brake units 5. An electrical power supply to the control unit 30a-1 is provided directly by the power source 24a integrated in the axle control module 4-1. This power source 24a is also used to supply electrical power to the control unit 30a-2 of the other axle control module 4-2 via an external connecting line. In a corresponding manner, the power source 24b, which is integrated into the axle control module 4-2, directly supplies the control unit 30b-2, which is also integrated into the axle control module 4-2, while the power source 24b supplies power to the control unit 30b-1 of the axle control module 4-1 via an external line connection. In this case, the electrical power supply 6 branches to connections of the two axle control modules 4-1, 4-2, which are each connected to the associated voltage converter 25-1, 25-2.

The axle control modules 4 can be arranged in the area of the axle and attached to the vehicle frame or chassis or an axle beam, for example.

The wheel brake units 5 are arranged adjacent to the associated vehicle wheel of the axle, preferably at a distance from the vehicle wheel or a brake of the vehicle wheel that is less than 1 m, 50 cm or even 30 cm. It is possible that the wheel brake unit is held on a wheel carrier or is attached directly to a brake calliper or the mechanical brake device.

In the context of the invention, a “controller” is understood to mean both a controller without feedback and a controller with feedback (“closed-loop control”).

Preferably, the coils 15a, 15b, the power sources 24a, 24b and the boosting devices 31a, 31b are each dimensioned such that the full braking functionality can be ensured by impacting only one set of coils 15a [or 15b] without the other set of coils 15b [15a] having to be additionally impacted.

### REFERENCE LIST

1 Electric braking system
2 axle
3 axle
4 Axle control module
5 Wheel brake unit
6 Electrical power supply
7 Vehicle bus system
8 Connection
9 Connection
10 Bus system
11 Connection
12 Brake signal cable
13 impact line
14 Brake actuator
15 coil
17 Force sensor
18 Travel sensor
19 Brake holding device
20 CAN transceiver
21 Connection
22 Connection
23 Control unit
24 power source
25 Voltage transformer
27 Connection
28 Connection
29 CAN transceiver
30 Control unit
31 Reinforcing device
32 Connecting cable
33 Insulator element
34 Connection

1.-17. (canceled)

18. An electric brake system, comprising:
a brake actuator including first coils configured such that an electrical impact of the first coils generate a first braking force, and second coils configured such that an electrical impact of the second coils generate a second braking force;
the electrical impact of the first coils and the electrical impact of the second coils are controllable via a first electronic control unit and a second electronic control unit.

19. The electric brake system according to claim 18, wherein the first control unit and the second control unit have different scopes of functions in a normal operating mode.

20. The electric brake system according to claim 18, wherein the first control unit and the second control unit each have a connection for a bus system.

21. The electric brake system according to claim 20, wherein the first control unit and/or the second control unit are/is connected to a central control unit of the vehicle via a connection and a bus system connected to the connection.

22. The electric brake system according to claim 20, wherein the first control unit and/or the second control unit are/is connected to a control unit of an axle control module via a connection and a bus system connected to the connection.

23. The electric brake system according to claim 20, wherein the first control unit and/or the second control unit are/is connected to a brake pedal sensor via at least one connection and a brake signal line connected to the connection.

24. The electric brake system according to claim 18, wherein the first control unit and the second control unit are connected to each other via a connecting line.

25. The electric brake system according to claim 18, wherein the first control unit includes control logic for monitoring the second control unit and/or the second control unit includes control logic for monitoring the first control unit.

26. The electric brake system according to claim 18, wherein brake signals are supplied to the control units, and wherein at least one control unit has a control logic configured to carry out a plausibility check of the brake signals supplied to the control units.

27. The electric brake system according to claim 18, wherein the first control unit is supplied with an actuating or position signal from an actuating travel or position sensor of the brake actuator, and wherein a force signal from a force sensor of the brake actuator is fed to the second control unit.

28. The electric brake system according to claim 18, wherein the first coils and the second coils of the brake actuator are supplied with electric power from different power sources.

29. The electric brake system according to claim 18, wherein the first control unit and the second control unit control a first amplification device and a second amplification device which generate the electrical impact signal for the first coils and the second coils of the brake actuator from a control signal of the control unit.

30. The electric brake system according to claim 29, wherein the first control unit and the second control unit are integrated in an axle control module.

31. The electric brake system according to claim 30, wherein the first and second amplification devices are integrated in the axle control module.

32. The electric brake system according to claim 18, wherein the first control unit and the second control unit are integrated in an axle control module.

33. The electric brake system according to claim 32, wherein the axle control module is connected to two wheel brake units of an axle, the first control unit comprises control logic for independently controlling the electrical impacts of first coils of the brake actuators of the two wheel brake units, and wherein the second control unit has control logic for independently controlling the electrical impacts of second coils of the brake actuators of the two wheel brake units.

34. The electric brake system according to claim 19, wherein the first control unit and the second control unit are integrated in a wheel brake unit.

35. The electric brake system according to claim 34, wherein the first control unit and the second control unit control a first amplification device and a second amplification device which generate the electric impact signal for the first coils and the second coils, and wherein the first and second amplification devices are also integrated into the wheel brake unit.

36. The electric brake system according to claim 35, wherein an axle control module is connected to two wheel brake units of an axle, and wherein the axle control module has a first power source connected to the first amplification devices of the two wheel brake units and a second power source connected to the second amplification devices of the two wheel brake units.

37. The electric brake system according to claim 18, wherein the two control units are each connected to a brake holding device of the brake actuators.
